(19) United States
(12) Patent Application Publication
(10) Pub. No.: US 2002/0101950 A1
(43) Pub. Date: Aug. 1, 2002

(54) Magnetic system from magnetic cells for fusion process

(76) Inventor: Vladimir Moses Lirtsman, Walnut Creek, CA (US)

Correspondence Address: VLADIMIR MOSES LIRTSMAN, 3120 OAK RD. BLD 7 #107, WALNUT CREEK, CA, 94596, US

(21) Appl. No.: 09/792,592

(22) Filed: Feb. 26, 2001

Related U.S. Application Data
(60) Provisional application No. 60/222,977, filed on Aug. 4, 2000.

(51) Int. Cl. G21B 1/00; G21J 1/00

(52) U.S. Cl. 376/142

(57) ABSTRACT

Magnetic System consist from twenty Magnetic Cells and their centers connection represent right dodecahedron. Magnetic System located inside reactor filled with hydrogen with needed beginning pressure and temperature. Magnetic Cell has inside minimum three arcs (10) from radioactive substance. These arcs emitted alpha particles. Arcs (10) located evenly on the same distances around Magnetic Cell's center and inside cases (11). Arcs only one side open. This side open to the Magnetic Cell's center, Holder (12) fasten with cases(11). Also holder intend to locate Magnetic Cell in the needed position.

Fusion process originated by emitted alpha particles' flows around centers of the Magnetic Cells.

Fusion process rise to the workable level by part from produced alpha particles' flows that exchange between closest Magnetic Cells.

Approximately 10 fusion process cycles occur per second.

From fusion process heated hydrogen's energy can be converted to the electric energy by using different technologies.

### BACKGROUND OF THE INVENTION

Experimental equipment : Tokamak (Russia), PLT (USA), Intor Demo (International Atomic Energy Agency) and other equipment and technologies was used to produce thermonuclear energy. Subscribed equipment used strong magnetic field for fusion process. In previous cases spending energy was bigger, that produced from fusion process. Please look chapter 13.3 (pages 618-625) in the book: ‘Experimental Nuclear Physics’, K.N. Mukhin, volume 1, Mir Publishers, 1987. Proposed Magnetic System used kinetic energy and magnetic field of the charge particles' flows for press and “superfast (about 10 sec..) heating of very small volumes of condensed thermonuclear materials.” (look: Experimental Nuclear Physics', K.N. Mukhin, volume 1, Mir Publishers, 1987, page 619). In quotation marks words took from this book. Charge particles' flows create magnetic fields inside Magnetic Cells. Magnetic System consist from Magnetic Cells.

### BRIEF DESCRIPTION OF THE SEVERAL VIEWS OF THE DRAWING

FIG. 1 shows the Magnetic Cell's view. This view is perpendicular to the triangle plane, that connect three Magnetic Cells' centers are closest to the presented Magnetic Cell. FIG. 2 show section view 1-1 from FIG. 1. FIG. 3 show section view 2-2 from FIG. 2. All parts' shape can be understood from the presented views.

### REFERENS NUMERALS

10—ARC

11—CASE

12—HOLDER

13—PIN.

### BRIEF SUMMARY OF THE INVENTION

Magnetic Cell consist from pieces of the radioactive substance. These pieces located around Magnetic Cell's center. From these pieces emitted alpha particles' flows collide with resultant force equal zero and producing fusion process around Magnetic Cell's center.

Magnetic System consist from twenty Magnetic Cells and their centers represent location of the imaginary right dodecahedron.

Magnetic System located inside the reactor. This reactor filled with hydrogen. Hydrogen will be needed beginning pressure and temperature.

Fusion process rise to the workable level by exchange part from produced alpha particles' flows between closest Magnetic Cells.

### DETAILED DESCRIPTION OF THE INVENTION

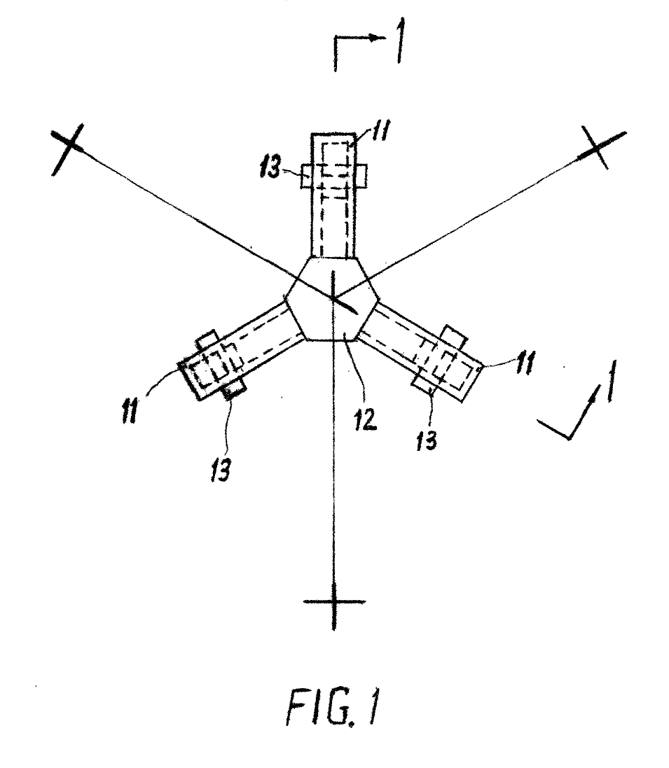

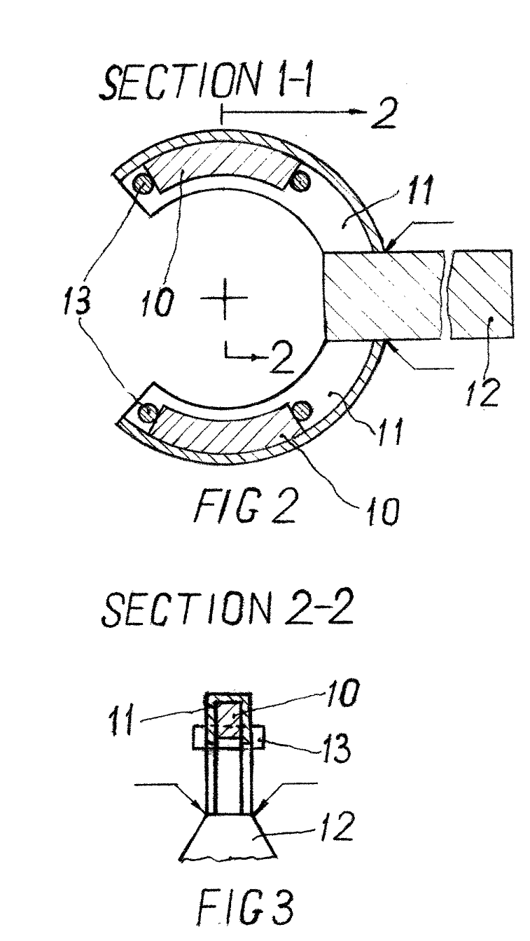

FIG. 1 shows the Magnetic Cell's view and three closest Magnetic Cells' centers to the presented Magnetic Cell. These three Magnetic Cells' centers show by crossing small lines. Connection snow by thin line between each two closest Magnetic Cell's centers and presented Magnetic Cell's center.

These thin lines represent three ribs projection or the imaginary dodecahedron that connect three centers of the Magnetic Cells.

These lines drew for understand how each Magnetic Cell located in the Magnetic System. Magnetic Cell has three partly circle shape cases 11.

Inside each case located less then 90 one circle arc 10 from radioactive substance. Cases 11 fasten to the holder 12 by welding.

Welding show by arrows' marks. Two pins 13 prevent arc 10 move along case 11. Case's two parallel walls must be pressed together so that arc 10 can not fall out from case 11. Magnetic Cell's cases and arcs have common center, that named center of the Magnetic Cell. This center shown on the FIG. 2 by crossing two small lines. For simplicity arcs' and cases' spherical surface changed to the cylindrical surface. Arc 10 middle point and Magnetic Cell's center located in the one plane, that named Center Plane of the Magnetic Cell. Center Plane is parallel to the triangle plane that connect three Magnetic Cells' centers. These three centers are closest to the presented Magnetic Cell. Arc's Plane is perpendicular to the Center Plane. Arc's middle curve and Magnetic Cell's center lay down in the Arc's Plane. Rib's Plane is perpendicular to the one Central Plane and go through two closest Magnetic Cell's centers. Between Arc's Plane and Rib's Plane is 60 at the presented Magnetic Cell. FIG. 2 shows one side of the Magnetic Cell open inside space of the Magnetic System.

This has purpose do not interrupt pressing process of the ions' flows between two closest Magnetic Cells and from Magnetic System's center. Hydrogen's atoms ionized by flying alpha particles. Moving, alpha particles' flows bring hydrogen's ions to the Magnetic Cell's center. Emitted alpha-particles begin the fusion process. Part from produced alpha particles rise fusion process to the workable level. Around center of the each Magnetic Cell alpha particles' flows make volume in which hydrogen ions will be trapped and participate in the micro fusion process. After the micro fusion process will be accomplish micro explosion take place and then everything is repeated automatically.

This Magnetic System work by cycles. Approximately 10 cycles occur per second around each Magnetic Cell's center. Also fusion process occur around Magnetic System's center from produced alpha particles and hydrohen ions.

There produced alpha particles help press ions' flows, that move between closest Magnetic Cells. Inside Magnetic System follow events occur: 1. Same charge flows attract each other by magnetic forces, if angle is sharp or 0 between them. 2. Same charge flows don't influence each other by magnetic forces, if angle is 90 between them. 3. Same charge flows repulse each other or collide by magnetic forces or can go through each other, if angle is obtuse or 180 between them.

What will happen in the last case depends on how much meeting flows pressed and how much these flows have kinetic energy. On the middle between two closest Magnetic Cells two produced alpha particles' flows meet and go through each other, because here is to weak pressed forces between ions' flows. Around Magnetic Cell's center angle rise from 108 to 120 between coming each two produced alpha particles flows. This happen under magnetic forces between each two ions' flows from three ions' flows coming inside Magnetic Cell.

Angles sum will become 360 between three coming ions' flows around each Magnetic Cell's center. Some time used term alpha particles' flows, but right term will be ions' flows, because alpha particles ionize hydrogen and alpha particles flows become mixed with hydrogen ions. Some produced alpha particles do not participate in the fusion process, but they help rise temperature of hydrogen inside reactor. Inside reactor heat can be converted to the electric energy by using different technologies.

Produced alpha particles' kinetic energy can be used in a space engine or for cut hard materials. Produced alpha particles have beginning speed 0.355 ×10 m/sec and beginning temperature 0.2025 ×10 K.

Produced energy is cheap and clean for the environment.

The Fusion Process must stay on a reasonable level. Inside the reactor the pressure and the temperature must be less then the radioactive substance melting conditions.

This can be achieved by choosing the right distance between the closest magnetic cells centers. This distance chosen so, that the produced alpha particles' cycle time must contain whole number cycles time for emitted alpha particles.

If inside the reactor the pressure and the temperature will rise to the maximum chosen level, then the fusion process will stop automatically, because alpha particles will not have the kinetic energy to overcome this condition.

After the pressure and the temperature will be lower inside the reactor from the chosen maximum by heat exchange inside the heater, the fusion process will establish again automatically.

I claim:

1. Magnetic System consist from twenty Magnetic Cells and their centers location represent right dodecahedron.

2. Magnetic System located inside volume with hydrogen.
Hydrogen will be with needed beginning pressure and temperature.

3. Magnetic Cell consist from radioactive substance pieces. These pieces located around Magnetic Cell's center with distance, that give possibility begin micro fusion process around this center.
These pieces must emit enough alpha particles per unit time to begin micro fusion process.
These pieces only one side open to the Magnetic Cell's center.

4. Distance chosen so between each two closest Magnetic Cell's centers, that in some moments emitted and produced alpha particles' flows create micro fusion process around these centers.

5. Emitted and produced alpha particles flows must collide around each Magnetic Cell's center with resultant force equal zero and with producing micro fusion process.
